(19) United States
(12) Patent Application Publication
(10) Pub. No.: US 2026/0154618 A1
(43) Pub. Date: Jun. 4, 2026

(54) UPDATING MACHINE LEARNING MODEL FOR PROVIDING POTENTIAL MATCHES BASED ON REAL-TIME FEEDBACK

(71) Applicant: Spark Networks, Inc., South Jordan, UT (US)

(72) Inventors: Brian Weinreich, Chappaqua, NY (US); Zachary Schleien, New York, NY (US)

(21) Appl. No.: 19/395,174

(22) Filed: Nov. 20, 2025

Related U.S. Application Data
(60) Provisional application No. 63/727,289, filed on Dec. 3, 2024.

(51) Int. Cl. G06N 20/00; G06Q 50/10

(52) U.S. Cl. CPC G06N 20/00; G06Q 50/10

(57) ABSTRACT

Method and computer-readable media for updating an online dating model for providing potential matches on an online dating service based on real-time feedback. The method includes conducting, at a user device, a video date with a candidate. The method includes receiving, at the user device, feedback information comprising a selection of one or more tags or descriptors related to the candidate, wherein the one or more tags or descriptors correspond to feedback or a review of the candidate. The method includes providing the selection of the one or more tags or descriptors of the user to an online dating platform. The method includes receiving, from the online dating platform, a set of future candidates based at least on a profile preference of the user.

### CROSS-REFERENCE TO RELATED APPLICATION

This application claim priority to U.S. Provisional Application No. 63/727,289, filed on Dec. 3, 2024, the entirety of which is incorporated herein by reference.

### FIELD

The present disclosure relates generally to a configuration for updating model search criteria for providing future matches based on feedback from prior matches.

### BACKGROUND AND SUMMARY

The use of artificial intelligence and machine learning models can include central models that accumulate and process data from multiple sources. These central models can improve efficiency and accuracy. Aspects presented herein provide a system that balances efficient learning while upholding the highest standards of data privacy.

Aspects disclosed herein enable individual users to use collected feedback data with artificial intelligence (AI) or machine learning (ML) tools in a way that enhances or optimizes the user experience on a dating application by using real-time feedback from the individual users, received at a user interface of a user device, to refine future dating matches. These AI tools may be configured to process the collected feedback data and gather information in relation to the real-time feedback of a previous video date. These AI tools at a central model may identify or observe patterns or preferences of users based on the real-time feedback of their experience with the previous video date. These AI tools may utilize the feedback data and optimize the manner in which future matches are provided for display at a user interface of a user device in response to the real-time feedback from the users. However, the ability for AI tools to utilize feedback data may be challenging due in part to requirements to safeguard sensitive user information and/or the substance of the real-time feedback.

Aspects presented herein provide for processing user feedback data related to the user experience with a video date, such that sensitive user information has been removed from the feedback data. This processed feedback data may then be provided to an online dating platform that processes the feedback data to update patterns or preferences based on user real-time feedback

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating an example of a video date between a user and a candidate.

FIG. 2 is a diagram illustrating an example of a user interface providing one or more descriptor tags of the candidate.

FIG. 3 is a block diagram illustrating user devices configured to interface with the online dating platform, in accordance with various aspects of the present disclosure.

FIG. 4 illustrates an example user device configured to interface with the online dating platform, in accordance with various aspects of the present disclosure.

FIG. 5 illustrates an example online dating platform for a machine learning model that interacts with a user device, in accordance with various aspects of the present disclosure.

FIG. 6 is a flowchart illustrating a method for providing feedback data to the online dating platform, in accordance with various aspects of the present disclosure.

FIG. 7 is a flowchart illustrating a method for updating a machine learning model of the online dating platform using feedback information received from a user, in accordance with various aspects of the present disclosure.

FIG. 8 is a block diagram of a computer system on which the disclosed system and method can be implemented, in accordance with various aspects of the present disclosure.

### DETAILED DESCRIPTION

Online dating services may allow a user to select a candidate based on a profile for each potential candidate. The profile of the potential candidate is typically written by the candidate themselves, and users base their decision to select the potential candidate based on the information the candidate provides in their profile. Users of online dating services typically review large quantities of candidate profiles prior to selecting one or more candidates. The candidate profiles may have vast information related to the interest and background for each of the candidates. However, the candidate profiles are typically drafted to highlight the best qualities of the candidate, but such profiles may not allow for people that have gone on a date with such candidate to provide feedback on the candidate. In some instances, feedback provided for a candidate may not be anonymous such that the person leaving positive or negative feedback may be easily identifiable.

Online dating services may seek to allow users to provide feedback of candidates that a user has conducted a video date with, such that the feedback of the candidate may be use with artificial intelligence (AI) tools in an effort to enhance or optimize the manner in which future candidates are suggested to the user of the online dating service. These AI tools may be configured to process the collected user feedback data and gather information in relation to preferences of the user. These AI tools may identify or observe patterns or preference changes of users while interacting with a candidate while on a video date. These AI tools may utilize the feedback data and optimize the manner in which future candidate are provided in response to the observed patterns or preferences of the user. However, the ability for AI tools to utilize feedback data may be challenging due in part to requirements to safeguard sensitive user information.

Aspects presented herein provide for an online dating platform that utilizes feedback received from users at remote user devices based on previous video dates to enhance or improve the selection of future candidate provided to the user. A profile preference or pattern may be determined for the user based on the feedback information provided, where the feedback information does not include information that identifies the user. Instead, user information is abstracted and the user shares profile preferences or patterns with a central AI/ML model of the online dating platform. The central AI/ML model may update the profile preference model based on shared profile preference or patterns from the user real-time feedback, and may provide profile preference updates for the user, ensuring rapid improvements in future candidate offerings while addressing individual user needs.

For example, aspects disclosed herein include processing user feedback data related to the user experience with a video date, using a central AI/ML model that interacts with multiple remote user devices, and that processes feedback received at such remote user devices so that sensitive user information has been removed from the feedback data before sharing any identified profile preference or patterns with a central AI/ML model of the online dating platform that processes the received information to update patterns or preferences based on user real-time feedback.

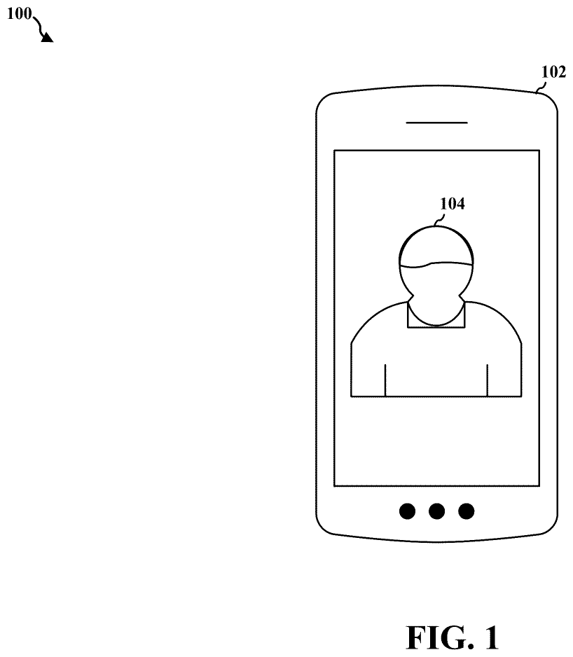

In some instances, as shown for example in diagram 100 of FIG. 1, a user may conduct a video date with a candidate 104. The video date may be conducted by initiating an application on a device 102. The device 102 may comprise a smartphone, tablet, desktop, laptop, or the like. The device 102 may have a wired or wireless connection with an internet service that allows for the video date with the candidate 104 to occur. During the video date, the candidate 104 and the user may speak with each other for a duration of time. The duration of time may be configurable or pre-determined. During the video date, the user and the candidate 104 typically communicate with each other and get to know each other better. The video date between the user and the candidate 104 may terminate after the duration of time, and the user may then be able to provide real-time feedback on their experience of the video date with the candidate 104.

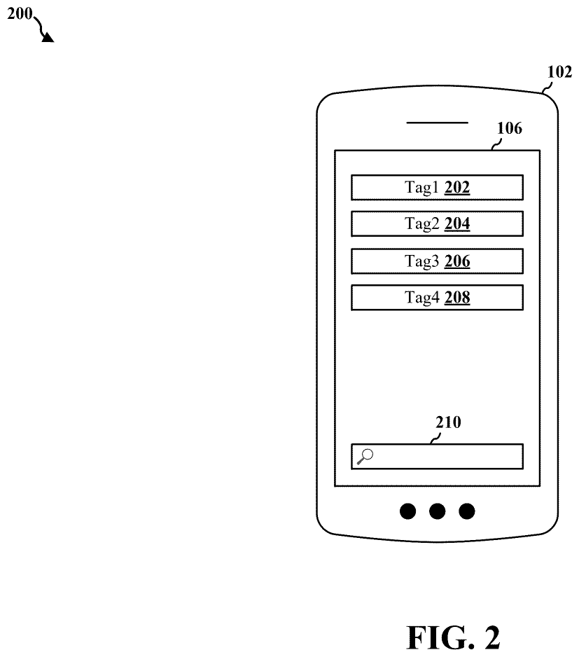

With reference to diagram 200 of FIG. 2, upon termination of the video date with the candidate 104, a user interface 106 of the device 102 provides one or more tags (e.g., tag 1 202, tag 2 204, tag 3 206, tag 4 208) that may apply to summarize the user's experience of the video date with the candidate 104. The tags may allow for the user to provide their impression of the candidate 104 in real-time. The tags may be a list of preset tags that may be commonly used to describe the candidate in an effort to simplify the feedback process. The tags may range from positive sentiments (e.g., funny, intelligent, kind, etc.), to neutral sentiments (e.g., indifferent, ambivalent), or to negative sentiments (e.g., arrogant, boring, insensitive, etc.). In some instances, if the pre-populated tags do not describe the feedback the user would like to provide with regards to the candidate, or the user would like to provide additional feedback, then the user may utilize a search feature 210 with the user interface 106. The search feature 210 may allow the user to enter keyword or phrases that may correspond to one or more tags that the user may select. In some instances, the user interface may provide an option for a voice-to-text function to allow the user interface to capture the sentiments or real-time feedback of the user. The voice-to-text function may convert the speech into tags. This features may be particularly useful for users who are visually impaired or prefer hands-free interaction. In some instances, the user interface may comprise support for multiple languages. This feature may be available in multiple languages, allowing users from different linguistic backgrounds to provide feedback without language being a barrier. In some instances, context sensitive tags based on the context of the content of the video date may be provided on the user interface upon the conclusion of the video date. For example, if the user and the candidate talked a lot about a particular subject or activity (e.g., movies, travel, cooking, etc.), tags related to such particular subject or activity (e.g., film buff, cinematic knowledge, foodie, loves to travel, etc.) may be included within the one or more tags. In some instances, the user may rate the overall quality of the video date experience, including the video and audio quality, which may be valuable feedback for the online dating service.

In some instances, a user (e.g., 304a-c) may receive an initial set of candidates based on the user interactions with the online dating service. For example, the user may setup an account with the online dating service and may provide some biographical information of the user, as well as some initial preferences for candidates. The user may select at least one candidate from the initial set of candidates to conduct a video date. At the end of the video date, the user may enter a review of the candidate, and this feedback data may be provided to the online dating service in an effort to enhance future candidates provided to the user. The feedback data may be processed such that sensitive user information within the feedback data may be removed, such that information with regards to user interactions (e.g., feedback data) with the online dating service is present while any such sensitive information of the user is not present. The processed information without any sensitive user information may be utilized to optimize services (e.g., future candidates, user experience) offered to the user. The feedback given by users will be anonymous and aggregated, such that individual tags are not visible to the candidates reviewed, thus ensuring anonymity and privacy and avoiding unnecessary conflict or harassment.

The online dating service may utilize feedback information related to a recently conducted video date between the user and the candidate in an effort to optimize or enhance the future candidates provided to the user. The future candidates provided to the user may be based on the feedback information, such that the future candidates have attributes that correspond or match with feedback information provided by the user. In some aspects, the processed information may be utilized to optimize the user experience with the online dating service. For example, the online dating service may utilize the user feedback information for a variety of different metrics in relation to providing future candidates to the user, such as but not limited to partner compatibility, sentiment trends, match predictors, psychological insights, or the like.

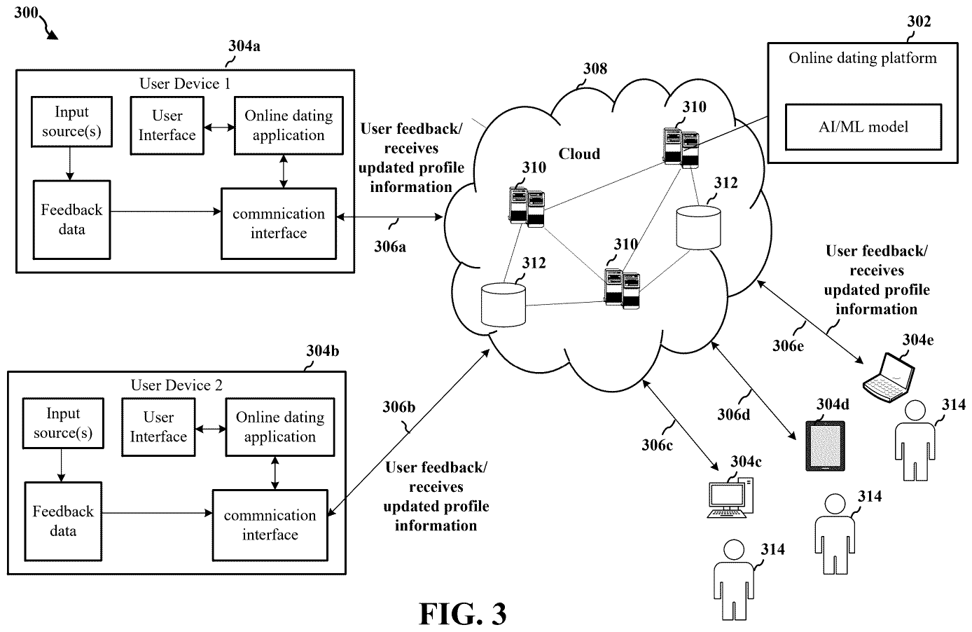

FIG. 3 illustrates a diagram showing a system 300 including various aspects of logic based learning for an AI/ML model. FIG. 3 shows an online dating platform 302 that includes one or more AI/ML models. In some aspects, each model may correspond to a particular type of service offered by the online dating service or may correspond to specific sentiment patterns. As an example, an AI/ML model may be a model for enhancing future candidate selections. As another example, an AI/ML model may be for enhancing the user experience with the online dating platform (e.g., partner compatibility, sentiment trends, match predictors, psychological insights). Although specific examples of AI/ML models are given to illustrate the concept, the aspects presented herein may be applied for AI/ML models for various types of services provided by the online dating service.

Individual user devices (e.g., user device 1 304a, user device 2 304b, user device 3 304c, user device 4 304d, or user device 5 304e) may each have a communication interface that exchange information with the AI/ML model at the online dating platform 302. In some aspects, the online dating platform may use feedback from individual user devices to update the AI/ML model at the online dating platform to the individual users. As illustrated, the user devices may otherwise obtain the AI/ML model and establish a communication connection (e.g., 306a, 306b, 306c, 306d, 306e) to the AI/ML model at the online dating platform 302. The connection may be provided as a communication interface between the remote AI/ML model and the central AI/ML model. The communication connection or communication interface allows software and data to be transferred between computer systems or user devices and external devices. Examples of communications interfaces may include a modem, a network interface (such as an Ethernet card), a communications port, a Personal Computer Memory Card International Association (PCMCIA) slot and card, etc. Software and data can be transferred via communications interfaces in the form of signals, which may be electronic, electromagnetic, optical or other signals capable of being received by communications interface. These signals can be provided to communications interface via a communications path (e.g., channel). The communication interface may include a model, a network interface, a communications port, and/or other components to enable the exchange of communication via a communication path (e.g., whether wire, cable, fiber optic, wireless link, and/or other communication channel between computer systems).

FIG. 3 also shows an example of a communication system that may support one or more accessors 314 (also referred to interchangeably herein as one or more “users”) and one or more user devices (which may also be referred to as terminals) 304a-e. In some aspects, data for use in accordance with aspects presented herein, for example, input and/or accessed by users 314 via remote user devices 304a-e, such as personal computers (PCs), minicomputers, mainframe computers, microcomputers, telephonic devices, or wireless devices, such as personal digital assistants (“PDAs”) or a hand-held wireless devices coupled to a server 310 or other device having a processor and a repository for data and/or connection to a repository for data, via, for example, a network 308, such as the Internet and couplings. The couplings include, for example, wired, wireless, or fiberoptic links. FIG. 3 illustrates an example in which various remote user devices may connect to the online dating platform 302 via a cloud 308 that may include one or more servers 310 and databases 312.

Each user device (e.g., user device 304a-e) may interact with the AI/ML model of the online dating platform independently. Each user may exchange information, e.g., both providing and receiving information, with the AI/ML model of the online dating platform 302 and to control the amount of information, e.g., including sharing of feedback information, and/or receiving an update of the preference profile, which is shared between a user and the online dating platform. In some aspects, users may select one or more tags that are important to them in a potential match, which may allow for a more personalized dating experience.

The online dating platform 302 may process the feedback information from the user device 304 using an AI/ML model 512 to detect new patterns or models based on a feedback information from the user and/or feedback information submitted by one or more previous candidates that conducted a video date with the user, e.g., using one or more processors 514 and memory 516.

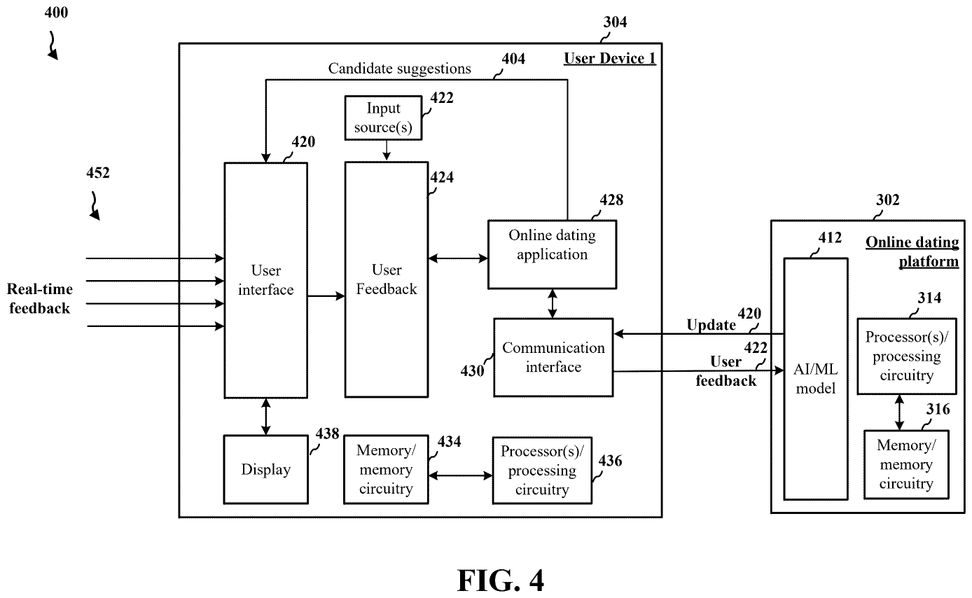

FIG. 4 illustrates a more detailed diagram 400 of an example user device (e.g., such as one of user device 304a-e from FIG. 3). As illustrated, the example user device 304 may include memory 434 (or memory circuitry) and one or more processors 436 (or processor circuitry) configured to cause the computer system to perform the aspects described in connection with the use of the online dating application, as described herein. The user device 304 may interface with the online dating platform via an application on the user device (e.g., mobile phone, laptop, desktop, or the like). The user device may also include a user interface, including a display 438, that is configured to display information received from the online dating platform to the user and to receive user input, at least some of which, the user device may provide to the online dating platform. The user device may include an online dating application 428 that is configured to process, understand, and interact in real-time with user specific data. The user device 304 may receive real time feedback data 452 input by a user via a user interface 420. For example, the user interface may display one or more tags that the user may select to review the video date recently held with the candidate. The feedback data may be based on the user's experience with the candidate during the video date. Data within input source(s) 422 may include information related to the user, as well as initial candidate parameters selected by the user. As an example, the data within input source(s) 422 may include input information related to search criteria for potential candidates, such as but not limited to, a geographic search region, age, education history, ethnicity, or other desired candidate attributes. The data within the input source(s) 422 may be updated by the user. The feedback data 424 may be provided to a AI/ML model 412 at the online dating platform 302 to generate an output based at least on the feedback data 424 and/or data from input source(s) 422, which may be output 404 as candidate suggestions. For example, the user device may include an online dating application 428 that receive information from the online dating platform 302 in order to present candidate suggestions 404 via the user interface 420 and to receive the user feedback via the user interface 420 and user feedback component 424. The online dating application 428 may provide the feedback to the online dating platform 302 via a communication interface 430.

The AI/ML model 412 may process the feedback data from the user to identify one or more preference patterns that may update or improve the accuracy of the output from the AI/ML model 412. The use of the AI/ML model 412 to analyze the feedback data 422 and the identification of patterns or variations is performed by the online dating platform separate from the user. The online dating platform may adjust the preference patterns of the AI/ML model 412 based on the analysis of feedback data 422.

In some aspects, the online dating platform may process abstracted feedback data and store the results within a database. The database may have a table structure that relates users to candidates based on the feedback information. The feedback data may be processed by the AI/ML model 412 of the online dating platform to obtain a preference pattern that is based on feedback data from the user.

The online dating application 428 may be configured to provide updates for candidate suggestions from the central AI/ML model 412, as shown at 420 (and 306a in FIG. 3) and share feedback information with the online dating platform, as shown at 422 (106e in FIG. 1). The user setting may provide a user interface that enables a user to select and change a setting at different times. For example, at a first time, the user may receive an initial set of candidates based on initial parameters or information provided by the user. The user may receive updated or different sets of candidates that are based on the feedback information of previous candidates. The selection of future candidates provided to the user may improve or enhance as the user goes on more video dates and provides feedback on such candidates.

The online dating platform 302 may process the feedback information from the user 304 using an AI/ML model 412 to detect new patterns or models based on feedback information from the user, e.g., using one or more processors 314 and memory 316. The new patterns or models based on the feedback information may provide the user with an updated set of future candidates based on the feedback information. The online dating platform 302 may aggregate the feedback information to form a sentiment profile for each user. This profile may be continuously updated based on new feedback from future dates. The online dating platform, over time, may continually gather data to form a nuanced profile that captures the complexities of human behavior and interaction. The gathered data may be used to modify or update the matching algorithm or model of the online dating platform. For example, if a user frequently receives the ‘Funny’ tag and is also looking for someone with a good sense of humor, the model may prioritize showing profiles of other users who have also been frequently tagged as ‘Funny’.

In some instances, the online dating platform may use the feedback dataset (e.g., user provided, candidate provided) not only to improve matches but also to offer tips and suggestions for users. For example, if a user frequently receives the tag ‘Arrogant’ from candidates, the online dating service may suggest articles or tips on how to come across as humbler or considerate in an effort to improve the user experience with the online dating service. In some aspects, based on the aggregated sentiment profile, the online dating platform may provide an indication to the user indicating a “Compatibility Meter” for each user and candidate pair. For example, the compatibility meter may offer a real-time, data-driven estimate of how compatible the user and candidate may be based on mutual tags and preferences. In some aspects, users may access a user dashboard that provides a summary of their received tags, which previous candidates have selected for the user, which may provide a trend over time. The user dashboard may include traits the user is most often matched with by previous candidates or traits the user most frequently selects when reviewing previous candidates. The user dashboard may be updated by the online dating platform based on the feedback data provided by the user and by the previous candidates. In some aspects, the user dashboard may identify sentiment trends over a period of time. For example, if a user consistently tags candidates as ‘funny’ but not as ‘kind’, the online dating platform may identify such act as a sentiment trend and notify the user. Such sentiment trend may be useful information for the user to consider when reflecting on what they value in a candidate match. In some aspects, the online dating platform may be configured to generate a match predictor. For example, the match predictor may predict a future match quality or score between the user and future candidates, based on the feedback provided by the user on previous candidates and feedback received by previous candidates. The future match quality may enhance the user experience by providing an enhanced engagement level with the online dating service. In some aspects, the online dating platform may comprise a psychological model used to correlate tags with psychological traits (e.g., “kind” may correlate with high empathy). Users might receive general insights into their dating behavior, although this would need to be handled carefully to avoid misinterpretation or stigmatization. In some instances, the online dating platform may provide the user with a “feedback score”. The feedback score may not be visible to other users, but may be made available for the users for their own self-improvement. The feedback score may provide an indication as to how users are perceived by previous candidates. For example, the feedback score may provide an indication of which feedback tags the user has received the most by previous candidates, or the rate at which one or more feedback tags have been selected by previous candidates when reviewing the user. In some instances, the online dating platform may provide for multi-dimensional matching between the user and future candidates. Instead of focusing on common interests or mutual ‘Likes’, this feature adds another layer of compatibility by including behavioral traits and interpersonal dynamics into the selection of future candidates.

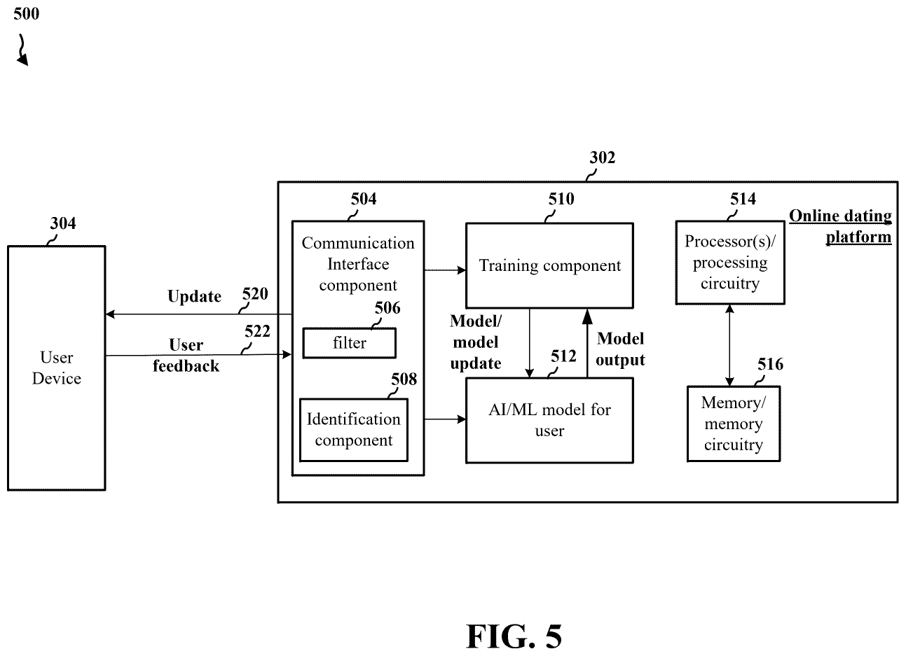

FIG. 5 illustrates a detailed diagram 500 of the online dating platform 302 (e.g., as discussed in connection with FIG. 3 and FIG. 4). The online dating platform 302 may be provided in one or more secure remote servers (e.g., cloud servers) that may include aspects described in connection with FIG. 3, for example. The online dating platform 302 may receive shared feedback information 522 as input at a communication interface component 504. The online dating platform 302 collects abstracted feedback information from the user. The online dating platform 302 processes the feedback information in an effort to refine the output of an AI/ML model 512, and generates, at least the updated set of candidates based on the feedback information, which may be provided to the user as an update 520. For example, the online dating platform processes and combines the feedback information to obtain an updated model based on at least the feedback information provided by the user. The communication interface component 504 may filter 506 the updated model to obtain relevant feedback information. The communication interface component 504 may identify new or changed preference patterns from the shared feedback information at identification component 508. The communication interface component 504 may train the updated model by providing data, to a training component 510 and/or a AI/ML model for user 512. The model training component 510 may assist in further training or updating a model based on the shared feedback information provided by the user, and may provide information to the AI/ML model for user 512. The AI/ML model for user 512 may provide a model output for training by the AI/ML model for user 512. The use of abstracted feedback information without information related to or identifying users helps to meet data privacy mandates, such as but not limited to the general data protection regulation (GDPR). The online dating platform utilizing the feedback information may improve the manner in which future candidates are selected and presented to the user may improve the user experience with the online dating platform while ensuring that user information is not included within the abstracted feedback information.

Thus, as shown in FIG. 3, the central processing system 302 may be configured to receive the feedback information from one or more users (e.g., 304a-c), where the feedback information is processed by the online dating platform to identify changes or updates in the user preferences based on the feedback information provided by the user. The online dating platform may update AI/ML information for the corresponding user based on the feedback information provided by the user, such that the user may use the updated model with their user device when interfacing with the online dating platform to enhance and/or optimize the user experience with the online dating platform (e.g., enhanced future candidate selections, etc.). The feedback information provided by the user enables user to update or enhance future candidates by sharing feedback information with the online dating platform while maintaining the privacy of the user.

In some aspects, for example, a user may provide feedback information to the online dating platform. The online dating platform may process the feedback information for new or updated patterns specific to the user, and may then provide the new or updated patterns, back to the user, to allow the user to obtain updated or enhanced future candidate selections based on the feedback information provided on previous candidates.

In some instances, the online dating platform may also provide the updated patterns to the user that may utilize the updated pattern based on feedback information derived from feedback provided on the user from previous candidates. The updated patterns do not have any sensitive user information related to the previous candidate and the feedback they provided on the user, but may have an updated pattern based on feedback provided by the previous candidates. The updated pattern that is being provided to the user based on feedback provided by the previous candidates is information that has been learned from the previous video dates between the user and previous candidates. The learned interactions may be useful in helping the user to receive an indication as to how previous candidates perceive the user on the online dating platform which assists to enhance or optimize the user experience on the online dating platform.

The feedback information may comprise a string of activity of user feedback without any identifying information of the actual user that were involved in the video date. The feedback information is in the abstract and only includes information related to the user feedback of the candidate, which may be utilized to determine patterns for enhancing the selection of future candidates for the user or how the user may interact with the online dating service.

The online dating platform may update the patterns that it provides to the users on a continual or predetermined basis. For example, when the online dating platform detects a new pattern based on the feedback information, the online dating platform may provide the updated pattern to the corresponding user automatically or at a predetermined time. The data stored at the online dating platform comprises the feedback information and does not include sensitive user information, such that user data is protected.

The online dating platform may provide users with an initial pattern or model that the user may utilize in making their initial candidate selections. The user may provide feedback information related to user feedback of previous candidates to the online dating platform, such that the online dating platform may process the feedback information and update the initial pattern or model provided to the user. The users may repeatedly provide the online dating platform with feedback information related to the updated pattern or model such that the online dating platform is continually updating or improving the pattern or model provided to the users. The updated patterns or models may be based on feedback information from the users and/or based on feedback information from previous candidates that reviewed the user.

For example, a user may provide feedback information to the online dating platform related to review of a first candidate. The online dating platform may utilize such feedback information from the user and update patterns or models which may then be provided to the user to select one or more future candidates for a potential video date with the user. The updated patterns or models may assist in the selection of future candidates provided to the user, such that the user may select a second candidate from the future candidates based on the review of the video date with the first candidate. The user may also utilize the updated patterns or models to obtain insight as to how previous candidates perceive the user on the online dating platform. For example, the user may receive a report or an indication that indicates an overview of feedback provided by previous candidates of the user. The overview of feedback may provide a general consensus of which tags were the most selected by the previous candidates. This may provide the user with information indicating how other users on the online dating platform are rating the user, such that the user may decide to maintain or employ different tactics while on video dates.

In some examples, natural language processing may be utilized for processing user feedback provided as textual or voice feedback.

Aspects presented herein are intended to maintain the privacy of each user. For example, the feedback information that may identify a user that reviewed a candidate that conducted a video date with the candidate is not shared with the candidate. The information of the user and any corresponding feedback provided on any candidate is intended to be anonymous such that the online dating platform does not share such identifying information to any user.

As an example of an AI learning flow, the AI/ML models 412 at the online dating platform may provide the user with an initial set of candidates from the online dating platform based on initial parameters selected by the user. The model 412 may evolve and improve the selection of future candidates based on the feedback information provided by the user as the user conducts more video dates.

The abstract feedback information, shared by the user, is provided to the online dating platform and the online dating platform processes the abstract feedback information. For example, the online dating platform 302 may update the model by continually using updated or additional feedback information that is provided by the user to the online dating platform. The online dating platform 302 may further use advanced neural architectures, such as transformer models ensuring comprehensive learning.

Once the online dating platform 302 determines an update to the AI/ML model 412 based on the abstract feedback information received from user, the online dating platform may provide an updated set of future candidate to individual users 304. In some aspects, the online dating platform may provide delta updates of future candidates so that changes in future candidate are transmitted as they are generated or at predetermined intervals in order to optimize bandwidth usage for the communication interface between the user 304 and the online dating platform 302.

In some aspects, the AI/ML model at the online dating platform (e.g., 512) may use machine-learning algorithms, deep-learning algorithms, neural networks, reinforcement learning, regression, boosting, or advanced signal processing methods for receiving content and identifying content of interest for particular users.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the online dating platform (e.g., 512) include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes. Neuron model connections may be modeled as weights, in some aspects. Machine learning models, such as the AI/ML model at the online dating platform (e.g., 512), may provide predictive modeling, adaptive control, and other applications through training via a dataset relating to feedback of previous candidate video dates. A machine learning model may be adapted, e.g., based on external or internal information processed by the machine learning model. In some aspects, a machine learning model may include a non-linear statistical data model and/or a decision making model. Machine learning may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning. During training, the machine learning model may be presented with an input that the model uses to compute to produce an output. The actual output may be compared to a target output, and the difference may be used to adjust parameters (e.g., weights, biases, coefficients, etc.) of the machine learning model in order to provide an output closer to the target output. Before training, the output may not be correct or may be less accurate. A difference between the output and the target output, may be used to adjust weights of a machine learning model to align the output is more closely with the target.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

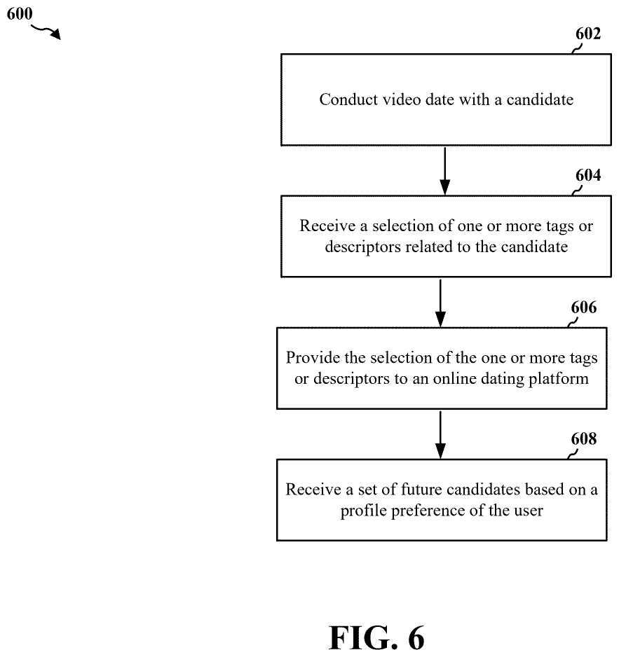

FIG. 6 is a flowchart 600 of a method of generating or updating a model based on feedback of a video date of a candidate by a user. The method may be performed at a user device operating an application configured to interface with the online dating platform. In some aspects, the method may be performed by an AI/ML component 875 of a processing system that may be part of a user 304.

At 602, a user may conduct a video date with a candidate using a user device. An example of video date with the candidate is described in connection with FIGS. 1-2. The video date with the candidate may be performed, e.g., in some aspects by the device 102 in FIG. 1. The user may conduct the video date with the candidate by interfacing with the online dating platform with the user device.

At 604, the user device may receive a selection of one or more tags or descriptors related to the candidate. The user device may provide a user interface that provides a prompt with the one or more tags or descriptors related to the candidate after the video date has ended between the user and the candidate. The user may select the one or more tags or descriptors related to the candidate to review, rate, or provide feedback of the candidate from the video date, as described in connection with FIG. 2. In some aspects, the user may select a search prompt to manually search one or more tags or descriptors if any of the pre-populated tags or descriptors does not match with an attribute or feedback label that the user would like to provide in relation to the candidate.

At 606, the user device may provide the selection of the one or more tags or descriptors to the online dating platform. Various aspects of processing and/or providing the selection of the one or more tags or descriptors are described in connection with FIG. 4.

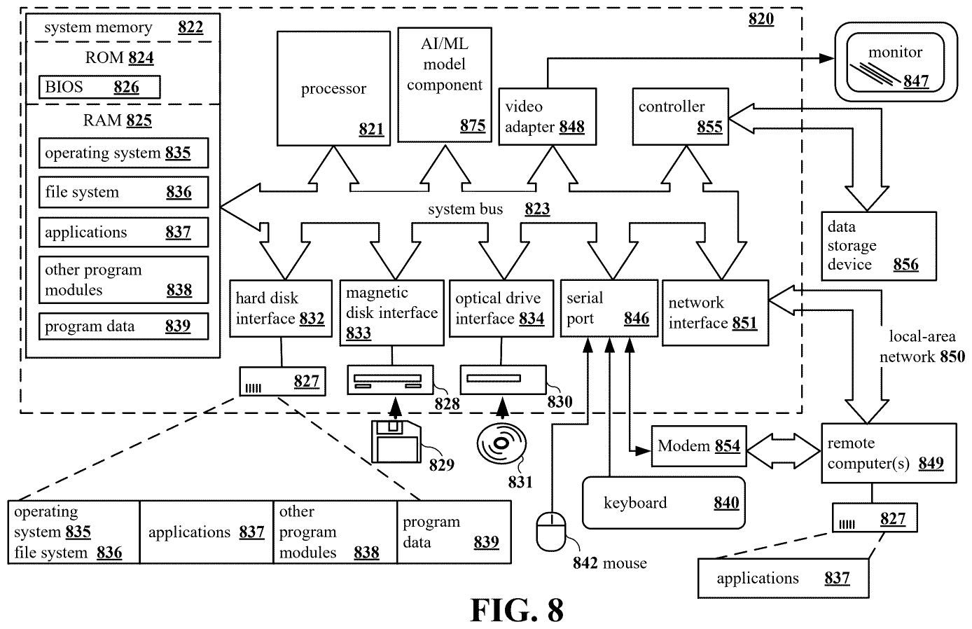

At 606, the user device may receive a set of future candidates based on a profile preference of the user. The set of future candidates may be based on an updated model determined by the online dating platform. The updated model may be updated by the online dating platform based on the profile preference of the user. The profile preference of the user may be determined by the online dating platform based at least on the feedback data provided by the user for each candidate that the user has conducted a corresponding video date. For example, the AI/ML model component 875 may provide the output to the monitor 847 in FIG. 8.

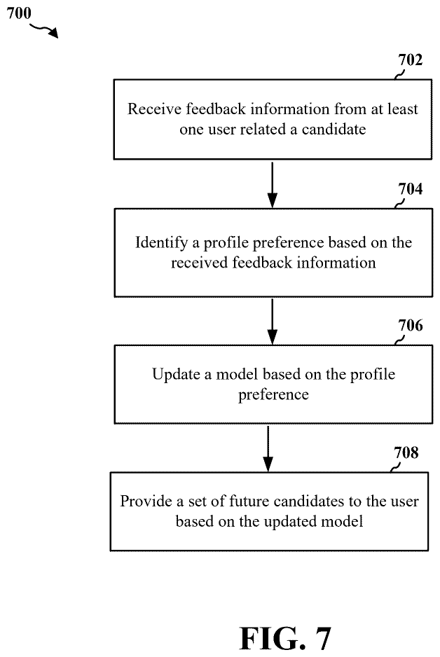

FIG. 7 is a flowchart 700 of a method of generating or updating a model based on user feedback of a candidate from a video date. The method may be performed at an online dating platform, e.g., 302. In some aspects, the method may be performed by an AI/ML component 875 of a processing system that may be part of the online dating platform 302.

At 702, an online dating platform may receive a feedback information from at least one user related to a candidate. The feedback information may comprise a selection of one or more tags or descriptors related to the candidate. The user device may collect the feedback information from the user, and provide the feedback information to the online dating platform. In some instances, the online dating platform may provide an initial set of candidate to the at least one user based on initial settings from the user. FIGS. 3-5 illustrate various example aspects of an online dating platform 302. In some aspects, the initial set of candidate and/or the feedback information may be provided via a communication interface between the online dating platform and the user.

At 704, the online dating platform may identify a profile preference of the user based on the received feedback information from the user. The profile preference may be based on the feedback provided by the user of the review of the candidate. In some instances, the model update may be based on feedback received from one or more candidates that reviewed the user based on previous video dates. FIGS. 3-5 illustrate example aspect of identifying an update of an AI/ML model of the user.

At 706, the online dating platform may update one or more AI/ML model updates based on the profile preference. At 708, the online dating platform may provide a set of future candidate to the user device based on the updated model. For example, as described in connection with FIGS. 3-5, at any given time, the interaction between the user device and the online dating platform may be controlled by the user.

FIG. 6 is a block diagram illustrating a general-purpose computer system 820 on which aspects of systems and methods for logic based learning between a user and a central AI/ML model, e.g., as described in connection with any of FIGS. 1-5 may be implemented in accordance with an example aspect. The computer system 820 can correspond to the physical server(s) on which the application 837 is executed, for example.

As shown, the computer system 820 (which may be a personal computer or a server) includes a processor 821 (e.g., central processing unit), a system memory 822, and a system bus 823 connecting the various system components, including the memory associated with the processor 821. As will be appreciated by those of ordinary skill in the art, the system bus 823 may comprise a bus memory or bus memory controller, a peripheral bus, and a local bus that is able to interact with any other bus architecture. The system memory may include permanent memory (ROM) 824 and random-access memory (RAM) 825. The basic input/output system (BIOS) 826 may store the basic procedures for transfer of information between elements of the computer system 820, such as those at the time of loading the operating system with the use of the ROM 824.

The computer system 820 may also comprise a hard disk 827 for reading and writing data, a magnetic disk drive 828 for reading and writing on removable magnetic disks 829, and an optical drive 830 for reading and writing removable optical disks 831, such as CD-ROM, DVD-ROM and other optical media. The hard disk 827, the magnetic disk drive 828, and the optical drive 830 are connected to the system bus 823 across the hard disk interface 832, the magnetic disk interface 833, and the optical drive interface 834, respectively. The drives and the corresponding computer information media are power-independent modules for storage of computer instructions, data structures, program modules, and other data of the computer system 820.

An example aspect comprises a system that uses a hard disk 827, a removable magnetic disk 829 and a removable optical disk 831 connected to the system bus 823 via the controller 855. It will be understood by those of ordinary skill in the art that any type of media 856 that is able to store data in a form readable by a computer (solid state drives, flash memory cards, digital disks, random-access memory (RAM) and so on) may also be utilized.

The computer system 820 has a file system 836, in which the operating system 835 may be stored, as well as additional program applications 837, other program modules 838, and program data 839. A user of the computer system 820 may enter commands and information using keyboard 840, mouse 842, or any other input device known to those of ordinary skill in the art, such as, but not limited to, a microphone, joystick, game controller, scanner, etc. Such input devices typically plug into the computer system 820 through a serial port 846, which in turn is connected to the system bus, but those of ordinary skill in the art will appreciate that input devices may be also be connected in other ways, such as, without limitation, via a parallel port, a game port, or a universal serial bus (USB). A monitor 847 or other type of display device may also be connected to the system bus 823 across an interface, such as a video adapter 848. In addition to the monitor 847, the personal computer may be equipped with other peripheral output devices (not shown), such as loudspeakers, a printer, etc.

Computer system 820 may operate in a network environment, using a network connection to one or more remote computers 849. The remote computer (or computers) 849 may be local computer workstations or servers comprising most or all of the aforementioned elements in describing the nature of a computer system 820. Other devices may also be present in the computer network, such as, but not limited to, routers, network stations, peer devices or other network nodes.

Network connections can form a local-area computer network (LAN) 850 and a wide-area computer network (WAN). Such networks are used in corporate computer networks and internal company networks, and they generally have access to the Internet. In LAN or WAN networks, the computer system 820 is connected to the local-area network 850 across a network adapter or network interface 851. When networks are used, the computer system 820 may employ a modem 854 or other modules well known to those of ordinary skill in the art that enable communications with a wide-area computer network such as the Internet. The modem 854, which may be an internal or external device, may be connected to the system bus 823 by a serial port 846. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

In one configuration, the AI/ML model component 875 and/or the computer system 820, and in particular, the file system 836 and/or the processor 821, is configured to perform the aspects of the flowchart in FIG. 6 or FIG. 7.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

An example implantation of the systems and methods described herein may include one or more of the following steps.

### Step 1: Post-Date

A mobile application may provide an interface where users can select tags or descriptors post-date. For example, after a video date has concluded, a screen on the mobile application may will show something like:
What did you think of Lisa?
She was...
[ ] funny
[ ] active
[ ] exciting
[ ] talkative
[ ] outdoorsy
[ ] serious

The selected data may, for example, be transmitted via a secure HTTPS connection to an API, where it may handle the logic of storing these tags in a database. The database may, for example have a table structure that relates users to dates and the corresponding feedback tags, such as:
Table: User_tags
   |user_id|match_id|tag_id|created_at|
   |INT (FK)|INT (FK)|INT (FK)|TIMESTAMP|
user_id: Foreign Key referencing the User table. This field identifies the user associated with a particular tag.
match_id: Foreign Key referencing the Match table. This field links to the specific match that the feedback pertains to. The match has a reference to the two users involved with the date.
tag_id: Foreign Key referencing the Tag table. This represents the individual tags or descriptors, such as ‘Funny,’ ‘Kind,’ ‘Arrogant,’ etc.
created_at: The timestamp of when the tag was added.
Relationships: Normalized relationships with the User, Match, and Tag tables for easy data retrieval and efficient storage.
Indexing: Use of indexing on foreign keys to optimize query performance.

### Step 2: Data Aggregation

The API may manage the aggregation of these tags to form a sentiment profile for each user. This may include counting the occurrence of each tag and organizing them by sentiment and personality categories. Redis may be used to cache these profiles, allowing for quicker access in subsequent matchmaking. Elasticsearch can be employed to provide basic scoring and matching, taking into account the categorical data. This creates a nuanced profile that evolves over time.

### Examples of Sentiment Categories:

Positive: Excited, Happy, Satisfied
Neutral: Indifferent, Ambivalent
Negative: Disappointed, Unhappy, Frustrated

### Examples of Personality Categories:

Humorous: Funny, Witty
Intellectual: Thoughtful, Insightful
Emotional: Sensitive, Empathetic
Adventurous: Daring, Exciting

These categories enable the system to understand and interpret user feedback in a more refined and insightful manner, aligning with human-like understanding of personality and sentiment. This categorization not only enhances the user matching experience but can also be leveraged for deeper analytics and user insight.

### Step 3: Algorithmic Adjustment

The API may have an updated matching algorithm that factors in the sentiment profile. For example, it could increase match scores for profiles that align with frequent positive tags like ‘Funny.’ Example features may include:
Sentiment-Weighted Scoring: Integrating sentiment profile as a weighted factor in the existing matching algorithm.
Dynamic Adaptation: Continuous learning from user feedback to refine matchmaking.
Integration with ChatGPT: Utilizing NLP models to analyze negative feedback and generate user-specific insights or improvement tips.
A/B Testing: Ensuring that the newly integrated sentiment-based feature does not compromise the existing user experience, with continuous testing.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A computer-implemented method for updating an online dating model for a user, comprising:
conducting, at a user device, a video date with a candidate;
receiving, at the user device, feedback information from the user comprising a selection of one or more tags or descriptors related to the candidate, wherein the one or more tags or descriptors correspond to feedback or a review of the candidate;
providing the selection of the one or more tags or descriptors of the user to an online dating platform; and
receiving, from the online dating platform, a set of future candidates based at least on a profile preference of the user, wherein the profile preference of the user is determined by the online dating platform based on the feedback information.

2. The computer-implemented method of claim 1, further comprising:
receiving, from the online dating platform, an initial set of candidates based on an initial set of parameters set by the user.

3. The computer-implemented method of claim 1, further comprising:
receiving, from the online dating platform, an indication of feedback information provided by one or more previous candidates related a review to the user.

4. The computer-implemented method of claim 3, wherein the feedback information comprises at least one of a partner compatibility, sentiment trends, match predictors, or psychological insights.

5. The computer-implemented method of claim 1, wherein the feedback information excludes information of the user within the feedback information provided in relation to the candidate.

6. A computer-implemented method for identifying feedback patterns for an artificial intelligence (AI) model of an online dating platform, comprising:
receiving, from a user device, feedback information from at least one user related to a candidate;
identifying a profile preference based on the received feedback information, wherein the profile preference is based at least on feedback information provided by the at least one user of a candidate from a video date between the candidate and the at least one user;
updating the AI model based on the profile preference, wherein the AI model is utilized to enhance candidate selection based at least on the feedback information; and
providing a set of future candidates to the at least one user based on the updated AI model.

7. The computer-implemented method of claim 6, wherein identifying the profile preference includes identifying variations in feedback patterns within the feedback information.

8. The computer-implemented method of claim 6, further comprising:
providing, to the at least one user, an initial set of candidates based on an initial set of parameters set by the at least one user.

9. The computer-implemented method of claim 6, further comprising:
providing, to the at least one user, an indication of feedback information provided by one or more previous candidates related to a review of the at least one user.

10. The computer-implemented method of claim 9, wherein the feedback information comprises at least one of a partner compatibility, sentiment trends, match predictors, or psychological insights.

11. The computer-implemented method of claim 6, wherein the feedback information excludes information of the user within the feedback information provided in relation to the candidate.

12. A computer-implemented system for identifying feedback patterns for an artificial intelligence (AI) model of an online dating platform, comprising:
one or more platform processors;
a non-transitory memory system; and
online dating software stored on the non-transitory memory system and executable by the one or more platform processers, when executed the online dating software being configured to
receive, from a user device over one or more networks, feedback information from at least one user related to a candidate,
identify a profile preference based on the received feedback information, wherein the profile preference is based at least on feedback information provided by the at least one user of a candidate from a video date between the candidate and the at least one user,
update the AI model based on the profile preference, wherein the AI model is utilized to enhance candidate selection based at least on the feedback information, and
provide, over the one or more networks, a set of future candidates to the at least one user based on the updated AI model.

13. The computer-implemented system of claim 12, wherein the online dating software is configured identify variations in feedback patterns within the feedback information to identify the profile preference.

14. The computer-implemented system of claim 12, wherein the online dating software is further configured to provide, to the at least one user over the one or more networks, an initial set of candidates based on an initial set of parameters set by the at least one user.

15. The computer-implemented system of claim 12, wherein the online dating software is further configured to provide, to the at least one user over the one or more networks, an indication of feedback information provided by one or more previous candidates related to a review of the at least one user.

16. The computer-implemented system of claim 15, wherein the feedback information comprises at least one of a partner compatibility, sentiment trends, match predictors, or psychological insights.

17. The computer-implemented system of claim 12, wherein the feedback information excludes information of the user within the feedback information provided in relation to the candidate.
